(19) United States
(12) Patent Application Publication
(10) Pub. No.: US 2021/0377718 A1
(43) Pub. Date: Dec. 2, 2021

(54) PATTERN AFFINITY FOR DISCOVERY

(71) Applicant: ServiceNow, Inc., Santa Clara, CA (US)

(72) Inventors: Tal Ben Ari, Petah Tikva (IL); Shimon Sant, Petah Tikva (IL)

(21) Appl. No.: 16/890,731

(22) Filed: Jun. 2, 2020

(51) Int. Cl. H04W 8/00; H04L 29/08; H04W 8/26; H04W 80/04; H04L 12/24

(52) U.S. Cl. CPC H04W 8/005; H04L 67/16; H04W 8/26; H04L 41/046; H04L 41/12; H04L 41/0806; H04W 80/04

(57) ABSTRACT

Systems, methods, and media for utilizing a discovery pattern affinity table are disclosed herein. The pattern affinity table includes one or more discovery patterns and associated data. The pattern affinity table is updated upon execution of a new or existing discovery pattern to reflect near real-time data associated with the discovery patterns. The pattern affinity table reduces an amount of time and computing resources needed to perform a discovery process by executing the discovery patterns stored in the affinity table.

### BACKGROUND

The present disclosure relates generally to techniques for performing discovery processes, and more specifically, to techniques for performing discovery processes based on discovery pattern affinity.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations. These remote resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment (e.g., servers and related software) or investing large amounts of time in establishing a private network infrastructure. Instead, by utilizing cloud computing resources, users are able redirect their resources to focus on their enterprise's core functions.

Certain cloud computing services can host a configuration management database (CMDB) that tracks information regarding configuration items (CIs) associated with a client. These CIs, for example, may include hardware, software, or combinations thereof, disposed on, or operating within, a client network. Additionally, the CMDB may define discovery processes jobs that are provided to a discovery server operating on the client network. The discovery server may execute the discovery processes to collect CI data that is provided to, and stored within, the CMDB.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments presented herein provide apparatus and techniques for executing and identifying discovery patterns associated with configuration items (CI) of a client network. More specifically, embodiments presented herein relate to utilizing a pattern affinity of one or more discovery patterns to input data associated with a network. The pattern affinity of the one or more discovery patterns may be stored in an affinity table that can be filtered and sorted to improve efficiency and reduce response times to a query request. The affinity table may include the one or more discovery patterns and data associated with the discovery patterns and/or one or more configuration items.

One embodiment presented herein includes a tangible, non-transitory, machine-readable medium. The machine-readable medium includes machine-readable instructions that are configured to cause operations to be performed when executed by a processor. The operations include receiving input data related to a network from a client device. The operations also include obtaining one or more discovery patterns from an affinity table. The operations also include filtering a plurality of discovery patterns based on an association of the plurality of discovery patterns to the input data, wherein the plurality of discovery patterns includes the one or more discovery patterns from the affinity table, and wherein remaining discovery patterns of the plurality of discovery patterns comprise a filtered plurality of discovery patterns. The operations also include ordering the filtered plurality of discovery patterns based on one or more parameters associated with each discovery pattern of the filtered discovery patterns, wherein the one or more parameters comprises the affinity of a respective discovery pattern of the filtered discovery patterns to the input data. The operations also include executing at least one of the ordered discovery patterns. The operations also include, upon successful execution of one of the discovery patterns of the plurality of discovery patterns, updating the affinity table to reflect results of the successfully executed discovery pattern.

Another embodiment disclosed herein includes a system comprising a discovery server coupled to an instance hosted by a cloud service platform and a client device, wherein the discovery server, the instance, and the client device are coupled to a network. The discovery server is configured to perform operations including receiving input data related to one or more configuration items coupled to the network. The operations also include receiving one or more discovery patterns from an affinity table from the instance. The operations also include filtering a plurality of discovery patterns based on an association of the plurality of discovery patterns to the input data, wherein the plurality of discovery patterns includes the one or more discovery patterns from the affinity table. The operations also include sorting the filtered plurality of discovery patterns based on one or more parameters of each discovery pattern of the filtered discovery patterns, wherein the one or more parameters comprises an affinity of a respective discovery pattern of the filtered discovery patterns to the input data. The operations also include executing at least one of the sorted discovery patterns. The operations also include, upon successful execution of one of the discovery patterns of the plurality of discovery patterns, updating the affinity table to reflect results of the successfully executed discovery pattern.

Still another embodiment disclosed herein includes a method for performing a discovery process using an affinity table. The method includes receiving input data related to a network from a client device. The method also includes obtaining one or more discovery patterns from an affinity table. The method also includes filtering a plurality of discovery patterns based on an association of the plurality of discovery patterns to the input data, wherein the plurality of discovery patterns includes the one or more discovery patterns from the affinity table, and wherein each discovery pattern in the plurality of discovery patterns includes data related to one or more configuration items. The method also includes ordering the filtered plurality of discovery patterns based on a timestamp of each discovery pattern of the filtered discovery patterns and the affinity of each discovery pattern of the filtered discovery patterns to the input data. The method also includes executing at least one of the ordered discovery patterns. The method also includes upon successful execution of one of the discovery patterns of the plurality of discovery patterns, updating the affinity table to reflect results of the successfully executed discovery pattern.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below.

FIG. 1 is a block diagram of an embodiment of a cloud architecture in which embodiments of the present disclosure may operate.

FIG. 2 is a block diagram of a computing device utilized in a computing system that may be present in FIG. 1, in accordance with aspects of the present disclosure.

FIG. 3 is an example of an affinity table that may be used during discovery, in accordance with aspects of the present disclosure.

FIG. 4 is a flowchart illustrating operations corresponding to one example of discovery using pattern affinity, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “affinity” refers to a relationship or association between data. For example, a pattern affinity between a discovery pattern and a particular configuration item (CI) and/or type of CI indicates that the discovery pattern has been successful in discovering one or more CIs during a previous discovery process for a network. The more recent the successful execution of the discovery pattern occurred, for example, the greater the affinity between the discovery pattern, the CI, and the network. As used herein, the term “affinity table” refers to a table including one or more discovery patterns and data associated with the one or more discovery patterns. The one or more discovery patterns in the affinity table may have been successfully executed within a period of time (e.g., within the preceding 30 days). The data associated with the one or more discovery patterns may include a configuration item (CI) type, an entry point type, an IP address of a corresponding client device, a timestamp, an operating system (OS), a pattern ID, a port, a source, and any combination thereof.

As discussed in greater detail below, the present embodiments described herein improve efficiencies in performing queries on a database. Due to the growing amount of data that may be present in a data storage or management system, executing and responding to query requests continue to increase in time and complexity. As a result, directing query requests to appropriate database engines may improve efficiency and/or reduce response times to query requests and may provide more useful analytical use cases. In one example, one or more databases may contain one or more sets of data entries. The one or more databases may include a row-oriented database and a column-oriented database.

After receiving a query request, a processor may determine whether the query request contains an analysis operation. If the query request contains an analysis operation, the processor may determine which of the one or more databases has data entries related to the query request. If a first database of the one or more databases contains data entries related to the query request, then the processor may send the query request to the first database for querying. If the first database does not contain data entries related to the query request, a replicator component may copy the relevant data entries from a second database to the first database before the processor sends the query request to the first database. On the other hand, if the query request does not contain an analysis operation, then the processor may send the query request to the second database. In one embodiment, the first database may be a column-oriented database and the second database may be a row-oriented database. In another embodiment, the first database may be a row-oriented database and the second database may be a column-oriented database.

Query requests that do not contain analysis operations may be sent to a row-oriented database due to how data is stored in a memory component (e.g. memory blocks) of the row-oriented database. Data blocks stored in the memory component associated with a row-oriented database include multiple types of data with respect to a column for one particular entity. With this in mind, updates to data blocks from a row-oriented database are relatively easier to implement compared to a column-oriented database. On the other hand, the processor may perform analysis operations more efficiently in column-oriented databases compared to row-oriented databases due to how data is stored in memory component of the column-oriented database. Data blocks stored in the memory component of column-oriented databases include multiple values for multiple entities, such that the multiple values are related to the same data type. As a result, since the data type of each column may be similar, performing analysis operations such as aggregating data within particular columns or queries involving executing certain algorithms on data stored in each column may be performed more efficiently, as compared to performing the same algorithms in data stored in different rows.

With this in mind, updating data entries in column-oriented databases may be relatively more difficult compared to row-oriented databases. For instance, when performing updates, which may be received as row-oriented cells, the processor may read through a certain number of rows in a row-oriented database to make the update. However, when the same update is made in a column-oriented database, the processor may read through a larger amount of columns as compared to the minimum number of rows before it may make the same row-oriented update as performed on a row-oriented database. As such, updating column-oriented databases may be especially time consuming if the column-oriented database contains a large volume of data entries.

To address the issue of updating a column-oriented database, the row with data entries to be updated may be deleted after receiving an indication that a modification to the data entries has been received. In place of the deleted row, a new row with the updated data entries may be inserted. Deleting the row may form separate deleted data structures using the data that was previously stored in the deleted row. Within a first reserve section of the column-oriented database, these separate deleted data structures are joined together with data entries associated with previously executed query requests (e.g., updates, modifications). The separate deleted data structures of the first reserve section may be permanently deleted on a periodic basis (e.g., daily, monthly), such that the first reserve section no longer includes the separate deleted data structures after the delete operation is performed. After the separate deleted data structures are deleted, new query requests may be directed to a second reserve section of the column-oriented database. In this way, the separate deleted data structures are maintained in such a manner that reserve sections of the column-oriented database are efficiently utilized and additional sections of the column-oriented database are available for data storage and query operations.

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized.

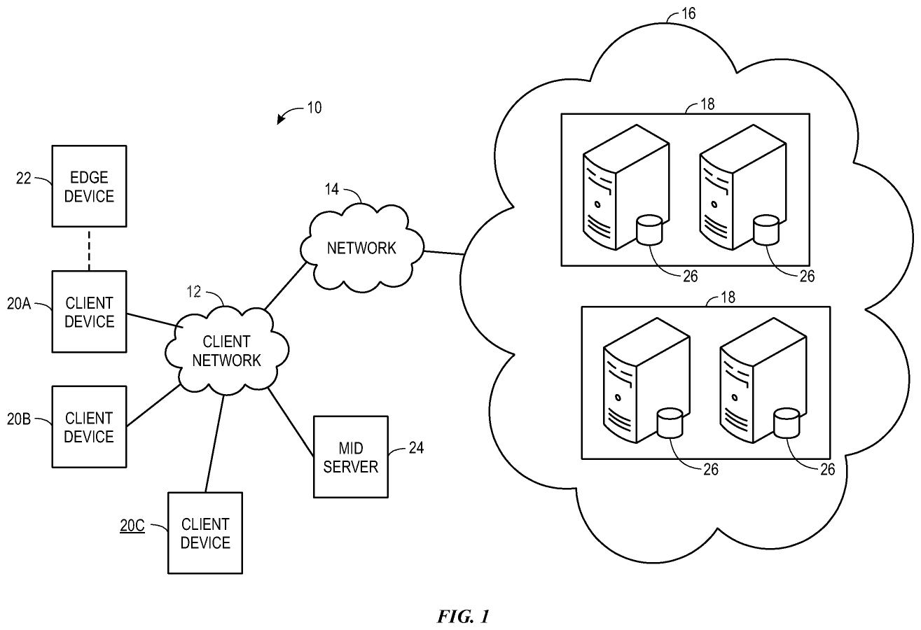

FIG. 1 is a schematic diagram of a cloud computing system 10 where embodiments of the present disclosure may operate. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks.

As shown in FIG. 1, the client network 12 is able to connect to one or more client devices 20A, 20B, and 20C so that the client devices are able to communicate with each other and/or with the network hosting the cloud-based platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16.

FIG. 1 also illustrates that the client network 12 includes an administration or managerial device, agent, or server, such as a MID server, which may function as or be implemented as a discovery server 24 as discussed herein) that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system. In some embodiments, the discovery server 24 may be a JAVA applet or similar application executing in the cloud-based platform 16.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center 18 could correspond to a different geographic location.

Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules.

Although FIG. 1 illustrates specific embodiments of a cloud computing system 10, the disclosure is not limited to the specific embodiments illustrated in FIG. 1. For instance, although FIG. 1 illustrates that the platform 16 is implemented using data centers, other embodiments of the platform 16 are not limited to data centers and can utilize other types of remote network infrastructures. The use and discussion of FIG. 1 are only examples to facilitate ease of description and explanation and are not intended to limit the disclosure to the specific examples illustrated therein.

As may be appreciated, the respective architectures and frameworks discussed with respect to FIG. 1 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

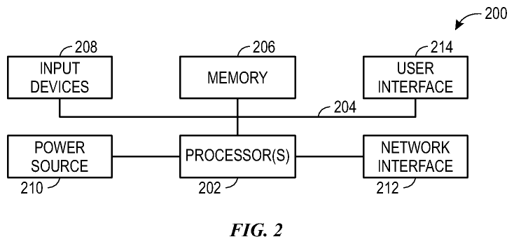

By way of background, it may be appreciated that the present approach may be implemented using one or more processor-based systems such as shown in FIG. 2. Likewise, applications and/or databases utilized in the present approach may be stored, employed, and/or maintained on such processor-based systems. As may be appreciated, such systems as shown in FIG. 2 may be present in a distributed computing environment, a networked environment, or other multi-computer platform or architecture. Likewise, systems such as that shown in FIG. 2, may be used in supporting or communicating with one or more virtual environments or computational instances on which the present approach may be implemented.

With this in mind, an example computer system may include some or all of the computer components depicted in FIG. 2, which generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. In some embodiments, the instructions may be pipelined from execution stacks of each process in the memory 206 and stored in an instruction cache of the one or more processors 202 to be processed more quickly and efficiently. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like.

The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

With this in mind, to improve efficiency in executing discovery patterns and responding to query requests, the computing system 200, as discussed in FIG. 2, may determine a pattern affinity for discovery patterns of a plurality of discovery patterns from previous results of a previous iteration of a discovery process to be used in re-discovery. A discovery pattern may include a series of operations to identify a corresponding configuration item (CI) associated with a client device. The discovery pattern may detect one or more attributes of a CI such as a type of entry point of the CI (HTTP, TCP, etc.), an IP address, a port, an operating system, software executing on the CI, memory, and the like.

A configuration item may refer to a record for any component or aspect (e.g., a computer, a device, a piece of software, a database table, a script, a webpage, a license, a piece of metadata, and so forth) in an enterprise network, for which relevant data, such as manufacturer, vendor, location, or similar data, is stored in a cloud-based platform, such as a CMDB. Thus, a discovery pattern can be used to identify various CIs in a particular network and various attributes associated with the CIs. Once the various CIs are identified, the discovery process updates the corresponding data in the cloud-based platform to reflect near real-time values. For example, if an IP address of the CI has changed since a previous discovery pattern was executed, the previous IP address of the CI is replaced with the current IP address in the cloud-based platform. A timestamp for the discovery pattern may also be updated.

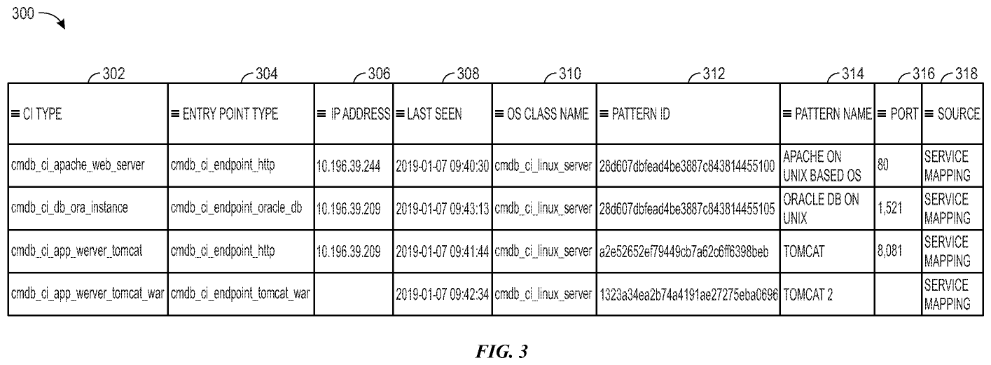

FIG. 3 illustrates an example of an affinity table 300 that may be used during a discovery process, such as a top-down (i.e., vertical) discovery process or a horizontal discovery process. The affinity table 300 includes one or more pattern affinities for a given discovery pattern. The affinity table 300 includes records associated with one or more respective discovery patterns 314. One or more affinity tables 300 may be stored on a remote server, such as the discovery server 24 discussed with respect to FIG. 1.

Input data for a particular discovery pattern 314 may include a CI type 302, an entry point type 304, an IP address 306 of a corresponding client device, a timestamp 308, an operating system (OS) 310, a pattern ID 312, a port 316, and a source 318. The CI type 302 may indicate one or more types of CIs corresponding to the discovery pattern 314. That is, a particular discovery pattern 314 may be used to discover a particular type of CI. The CI type 302 may include a database, an application server, an infrastructure service, an application, a web server, a load balancer, an endpoint (e.g., an entry point), and the like. In some embodiments, more than one discovery pattern 314 may be used to discover a single type of CIs, and/or a particular discovery pattern 314 may be used to discover multiple types of CIs.

The entry point type 304 may indicate how a particular CI can be accessed by a client. For example, the entry point type 304 may be an HTTP entry point, a TCP entry point, a server, and the like. The IP address 306 may be an IP address of the CI corresponding to the discovery pattern 314.

The timestamp 308 indicates the last time that the corresponding discovery pattern 314 was utilized during a discovery process. If a particular discovery pattern 314 is utilized during a subsequent top-down discovery process, the corresponding timestamp 308 is updated to indicate a time of the subsequent use of the discovery pattern 314. In some embodiments, the timestamp 308 may indicate the last time the corresponding discovery pattern 314 was successfully executed during the discovery process.

In some embodiments, the timestamp 308 for each discovery pattern may be used to determine a length of time each discovery pattern is retained in the affinity table. For example, a retention policy of the affinity table may be set to a particular period of time, such as about 30 days. When a difference in a current time and the timestamp 308 of a particular discovery pattern satisfies the retention policy, that discovery pattern may be removed from the affinity table. Removal of discovery patterns that have not been used or successfully executed for a period of time reduces an amount of time and computing resources to filter, order, and execute the discovery patterns, as discussed in more detail below.

The operating system 310 indicates an operating system executing on the corresponding CI. The pattern ID 310 is an identifier for the corresponding discovery pattern 314. The port 316 indicates an open or available port used to access the CI. The source 318 indicates a source of the discovery pattern 314. For example, a particular discovery pattern may be created during a discovery operation or a service mapping operation in which all CI's are discovered and a visual representation of the infrastructure and connections between the CI's is generated.

In some embodiments, the pattern affinity table 300 may be used to perform additional functions associated with the data therein. For example, the affinity table may be used as a debugging tool to, for example, identify a CI that is unable to connect to the network. To do so, results of an executed discovery pattern may be compared to results of a preceding discovery pattern. If the results are different (e.g., the CI is no longer found by the discovery pattern) and a time period between a timestamp associated with the results of the preceding discovery pattern and a current time satisfies a threshold, an alert may be generated to inform a user of a potential issue with the particular CI or the network.

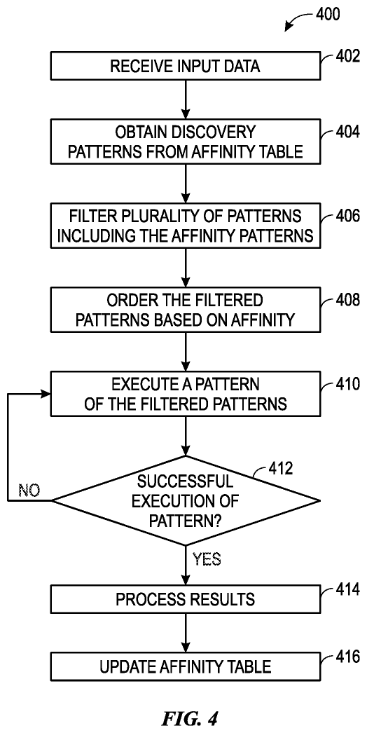

FIG. 4 is a flowchart 400 illustrating operations for top-down discovery using pattern affinity tracking, in accordance with aspects of the present disclosure. The operations of the flowchart 400 may correspond to instructions stored in memory, such as the memory 206 discussed with respect to FIG. 2, that are executed by a processor, such as the processor 202 discussed with respect to FIG. 2. The flow chart 400 begins at operation 402 where input data is received. The input data may include a query submitted by a user via a client device, such as the client devices 20A, 20B, 20C discussed with respect to FIG. 1. The input data may include a CI type, an entry point type, an IP address of a corresponding client device, a timestamp, an operating system (OS), a pattern ID, a port, and a source of a discovery pattern. The input data may be received from one or more input devices, such as the input devices 208 discussed with respect to FIG. 2.

At operation 404, one or more discovery patterns are obtained from an affinity table. The affinity table may be stored in a remote server and may include discovery patterns previously executed on one or more of the client devices 20A, 20B, and 20C. The affinity table includes the various input data for each discovery pattern identified therein. The affinity table may be stored on a physical storage device or in a cloud-based platform. In some embodiments, the affinity table is stored on the discovery server 24. In other embodiments, the affinity table is stored on a virtual server 26.

At operation 406, a plurality of discovery patterns is filtered. The plurality of discovery patterns may include the discovery patterns obtained from the affinity table and additional discovery patterns associated with the requesting client device. The additional discovery patterns may be stored locally on the requesting client device or in location remote from the client device. The plurality of discovery patterns are filtered so that the remaining discovery patterns include patterns that are associated with the requesting client device or the input data received at operation 402. That is, the filtered discovery patterns include discovery patterns that are associated with one or more of the input data such as a particular CI, CI type, entry point, or the like. Filtering the discovery patterns reduces an amount of time and computing resources used to execute each of the remaining discovery patterns during the discovery process. Thus, the filtering operation 406 improves an efficiency of performing the discovery process.

At operation 408, the filtered discovery patterns are ordered. The discovery patterns may be ordered based on one or more of the input data in the affinity table. For example, the discovery patterns may be ordered based on the timestamp. The discovery patterns may be further ordered based on an affinity to the input data where discovery patterns with an affinity are prioritized over discovery patterns that do not have a tracked affinity. For example, if the input data specifies “application server” as a CI type and an “HTTP” entry point type, discovery patterns associated with both the specified CI type and the entry point type may be ordered higher than a discovery pattern associated with only one of the specified CI type and the entry point type. Thus, discovery patterns with affinities tracked in the affinity table may be used before discovery patterns with no affinity tracked in the affinity table. As may be appreciated, executions of the patterns may consume a significant (e.g., majority) of the time used to complete the process reflected in the flowchart 400 especially when a large number of CIs and a large number of discovery patterns. Such a trial-and-error mechanism may take a few seconds to complete for a single CI, but for a large number (e.g., thousands) of CIs, the time for the discovery process may be excessively long without prioritizing discovery patterns with tracked affinity. Thus, the pre-knowledge regarding a discovery pattern that has an affinity for a particular parameter (e.g., entry point and/or host).

At operation 410, the discovery server 24 executes a first discovery pattern of the filtered and ordered patterns. The first discovery pattern in the filtered and ordered list of discovery patterns is executed to identify various CIs on a network and obtain data associated with the various CIs. For example, when the first discovery pattern is executed for a particular CI type, a discovery server, such as the discovery server 24 discussed with respect to FIG. 1, may gather the data associated with each CI identified by execution of the discovery pattern.

At operation 412, the discovery server 24 determines whether the executed discovery pattern (e.g., the first discovery pattern) was executed successfully. Successful execution of the discovery pattern occurs when execution of the discovery pattern returns data associated with one or more CIs on the network. If the discovery pattern was not executed successfully (i.e., no data was returned that is associated with one or more CIs on the network), the next discovery pattern in the filtered and ordered discovery patterns is executed at operation 410. The discovery process continues to execute the filtered and ordered discovery patterns until successful execution of a discovery pattern.

At operation 414, upon successful execution of a discovery pattern, the results of the successfully executed discovery pattern are processed. That is, the cloud-based platform 16 is updated to reflect current data associated with the identified CIs. In some embodiments, the results of the successfully executed discovery pattern may also be used on the client device to perform various operations, such as generating a network map. Although not illustrated in FIG. 4, the discovery process may execute at least some (e.g., all remaining) discovery patterns in the filtered and ordered discovery processes after the successful execution of the discovery pattern.

At operation 416, the affinity table for the plurality of discovery processes is updated to reflect the results of the executed discovery pattern(s). That is, the data associated with the executed discovery pattern(s) is updated to reflect the results of the data obtained from the execution of the executed discovery pattern(s). The updated data may include a timestamp the discovery pattern was executed, a port, an IP address, or the like that may be used to indicate an affinity of the discovery pattern in using the specific parameters (e.g., timestamp, port, IP address, etc.).

Utilizing a pattern affinity table reduces an amount of time and computing resources used to perform a discovery process by prioritizing successful discovery patterns from previous successful executions using one or more parameters. Thus, the pattern affinity table improves the functionality and performance of executing a discovery process.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A tangible, non-transitory, machine-readable medium, comprising machine-readable instructions, configured to:
receive input data related to a network from a client device;
obtain one or more discovery patterns from an affinity table;
filter a plurality of discovery patterns based on an association of the plurality of discovery patterns to the input data, wherein the plurality of discovery patterns includes the one or more discovery patterns from the affinity table, and wherein remaining discovery patterns of the plurality of discovery patterns comprise a filtered plurality of discovery patterns;
order the filtered plurality of discovery patterns in the affinity table based at least in part on an affinity of the discovery patterns of the filtered discovery patterns to the input data, wherein the filtered plurality of discovery patterns having an affinity to the input data are prioritized over discovery patterns without an affinity to the input data, and wherein the affinity of a respective discovery pattern of the filtered discovery patterns is based at least in part on a successful execution of the respective discovery pattern to discover at least one configuration item of one or more configuration items of the network;
execute at least one of the ordered discovery patterns; and
upon successful execution of one of the discovery patterns of the plurality of discovery patterns, update the affinity table to reflect results of the successfully executed discovery pattern.

2. The machine-readable medium of claim 1, wherein the affinity of a respective discovery pattern of the filtered plurality of discovery patterns is associated with a number of parameters in the affinity table matching the input data, wherein the parameters include at least one of an entry point, a host, a port, an IP address, and an operating system.

3. The machine-readable medium of claim 1, wherein the affinity of the filtered plurality of discovery patterns is based at least in part on a recency of a successful execution of the filtered discovery patterns.

4. The machine-readable medium of claim 3, wherein the affinity table is updated to reflect real-time data related to the at least one configuration item of the one or more configuration items.

5. The machine-readable medium of claim 3, wherein each of the one or more discovery patterns in the affinity table includes data associated with at least one configuration item of the one or more configuration items.

6. The machine-readable medium of claim 5, wherein the input data includes one or more of a configuration item type, an entry point type, an IP address, an operating system, a pattern identification number, a port, and a source of an associated discovery pattern.

7. The machine-readable medium of claim 6, wherein each of the filtered plurality of discovery patterns are associated with the input data.

8. The machine-readable medium of claim 6, wherein the configuration item type includes at least one of a computer, a device, a piece of software, a database table, a script, a webpage, and a piece of metadata associated with the device or the piece of software.

9. The machine-readable medium of claim 1, wherein each of the one or more discovery patterns are retained in the affinity table for a period of time.

10. A system comprising:
a discovery server coupled to an instance hosted by a cloud service platform and a client device, wherein the discovery server, the instance, and the client device are coupled to a network, and wherein the discovery server is configured to:
receive input data related to one or more configuration items coupled to the network;
receive one or more discovery patterns from an affinity table from the instance;
filter a plurality of discovery patterns based on an affinity association of the plurality of discovery patterns to the input data, wherein the plurality of discovery patterns includes the one or more discovery patterns from the affinity table;
sort the filtered plurality of discovery patterns in the affinity table based at least in part on an affinity of the filtered plurality of discovery patterns to the input data, wherein the affinity of a respective discovery pattern of the filtered plurality of discovery patterns is based at least in part on a successful execution of the respective discovery pattern to discover at least one configuration item of one or more configuration items of the network;
execute at least one of the sorted discovery patterns; and
upon successful execution of one of the discovery patterns of the plurality of discovery patterns, update the affinity table to reflect results of the successfully executed discovery pattern.

11. The system of claim 10, wherein the affinity of the filtered plurality of discovery patterns is representative of a relationship between the plurality of discovery patterns and the input data and indicates a recency of a successful execution of the plurality of discovery patterns.

12. The system of claim 10, wherein the sorted discovery patterns are executed in an order corresponding to the affinity of the plurality of discovery patterns.

13. The system of claim 10, wherein each of the one or more discovery patterns are retained in the affinity table for a period of time based on a timestamp associated with a respective discovery pattern.

14. The system of claim 10, wherein the input data includes one or more of a configuration item type, an entry point type, an IP address, an operating system, a pattern identification number, a port, and a source of an associated discovery pattern.

15. The system of claim 14, wherein the plurality of discovery patterns are filtered based at least in part on the configuration item type in the input data.

16. The system of claim 14, wherein the configuration item type includes at least one of a computer, a device, a piece of software, a database table, a script, a webpage, and a piece of metadata associated with the device or the piece of software.

17. A method comprising:
receiving input data related to a network from a client device;
obtaining one or more discovery patterns from an affinity table;
filtering a plurality of discovery patterns based on an association of the plurality of discovery patterns to the input data, wherein the plurality of discovery patterns includes the one or more discovery patterns from the affinity table, and wherein each discovery pattern in the plurality of discovery patterns includes data related to one or more configuration items;
ordering the filtered plurality of discovery patterns in the affinity table based at least in part on a timestamp of each discovery pattern of the filtered discovery patterns and an affinity of each discovery pattern of the filtered discovery patterns to the input data, the timestamp indicating a successful execution of a respective discovery pattern of the filtered discovery patterns, wherein the affinity of a respective discovery pattern of the filtered discovery patterns is based at least in part on a successful execution of the respective discovery pattern to discover at least one configuration item of one or more configuration items of the network;
executing at least one of the ordered discovery patterns; and
upon successful execution of one of the discovery patterns of the plurality of discovery patterns, updating at least a timestamp of the one of the discovery patterns in the affinity table.

18. The method of claim 17, wherein the affinity table is stored in a configuration management database and wherein the timestamp represents at least a portion of the affinity of the one of the discovery patterns to the input data.

19. The method of claim 17, wherein each of the one or more configuration items includes at least one of a computer, a device, a piece of software, a database table, a script, a webpage, and a piece of metadata.

20. The method of claim 17, wherein the input data includes at least one of a type of configuration item, an entry point type, an IP address, an operating system, a pattern identification, a port, and a discovery pattern source.
